(19) United States
(12) Patent Application Publication
(10) Pub. No.: US 2007/0004260 A1
(43) Pub. Date: Jan. 4, 2007

(54) Switchgear with a conductor connection created by means of a ring cable lug

(75) Inventors: Johann Drexler, Schwandorf (DE); Daniela Streble, Amberg (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, Munich (DE)

(21) Appl. No.: 10/569,549

(22) PCT Filed: Jul. 26, 2004
(86) PCT No.: PCT/EP04/08350

§ 371 Date: Feb. 27, 2006

(30) Foreign Application Priority Data
Aug. 28, 2003 (DE) 103 39 670.5

(51) Int. Cl. H01R 29/00

(52) U.S. Cl. 439/188

(57) ABSTRACT

A switchgear is disclosed with a conductor connection created via a ring cable lug. The switchgear includes a pre-mounted structural component provided with a holder and a screw with a washer assembly which is held by the holder and forms, together with a connection part, a clamping point for a conductor connection created by means of a ring shoe lug. The holder can be displaced between an open position and a closed position of the clamping point, and is subjected to the action of a spring element that holds it in the open position when the clamping point is released.

This application is the national phase under 35 U.S.C. § 371 of PCT International Application No. PCT/EP2004/008350 which has an International filing date of Jul. 26, 2004, which designated the United States of America and which claims priority on German Patent Application number DE 103 39 670.5 filed Aug. 28, 2003, the entire contents of which are hereby incorporated herein by reference.

### FIELD

The invention generally relates to a switching device. For example, it may relate to one having a conductor connection by way of a ring terminal. The switching device may include a preassembled component, including a holder and a screw-with-washer assembly which is held by the holder and forms, together with a connection piece, a clamping point for a conductor connection via a ring terminal.

### BACKGROUND

A switching device including a connection clamping apparatus has been disclosed in DE 196 14 371 A1. The connection clamping apparatus in this case has a cover, in which a plurality of connection clamping screws are held. The connection clamping screws each include a screw, an L-shaped washer, which is held loosely and such that it can rotate, and a spring disk. The L-shaped washer has a washer section and a guide plate section which protrudes at right angles with respect to the washer section.

The connection clamping screws are guided via the guide plate section for the purpose of closing and opening a clamping point formed by a connection clamping strip, the clamping point being designed to connect the conductor by way of a ring terminal.

At the point of installation of each connection terminal screw, a coupling claw is provided in the cover, the tip of the coupling claw holding the respective connection terminal screw in the open state of the clamping point. Once the clamping point has been released, the connection terminal screw needs to be brought into the position in which it is held by the tip of the coupling claw in the open state by way of a suitable additional tool in order to reconnect a conductor by means of a ring terminal. The cover forms, with the connection terminal screws, a component which is latched into the housing of the switching device.

### SUMMARY

At least one embodiment of the invention includes an object of improving a switching device such that a conductor connection, via a ring terminal, can be fixed in a simple and secure manner.

The holder can be moved between an open and a closed state of the clamping point, and has a spring element applied to it which holds it in the open state when the clamping point is released. In this case, it is possible for a conductor to be reconnected via a ring terminal once the clamping point has been released without an additional tool being required. This is a considerable advantage in terms of assembly which considerably reduces the time expenditure and thus also costs.

One advantageous development of at least one embodiment of the invention is provided if the component is not provided with a cover, since in this case the clamping point is easily visible and it is thus possible to recognize at a glance whether the clamping point is in the open or closed state.

One further advantageous development of at least one embodiment of the invention is provided if the component is guided and held via guide grooves during assembly. This embodiment not only ensures secure guidance during assembly, but is also effective in holding of the component.

### BRIEF DESCRIPTION OF THE DRAWINGS

One example embodiment of the invention will be explained in more detail below with reference to the drawings, in which:

FIG. 1, FIG. 2, and

FIG. 3 show the design of a preassembled component for the conductor connection by means of a ring terminal and its use in a housing,

FIG. 4 shows a clamping device having a plurality of components in a housing,

FIG. 5 shows a cross section through a clamping device as shown in FIG. 4 with a component latched in the housing,

FIG. 6 shows a clamping device having an open clamping point, which is brought about by a spring element,

FIG. 7 shows a clamping device having a clamping point in the closed state, and

FIG. 8 shows a clamping device which has been snapped into the switching device.

### DETAILED DESCRIPTION OF THE EXAMPLE EMBODIMENTS

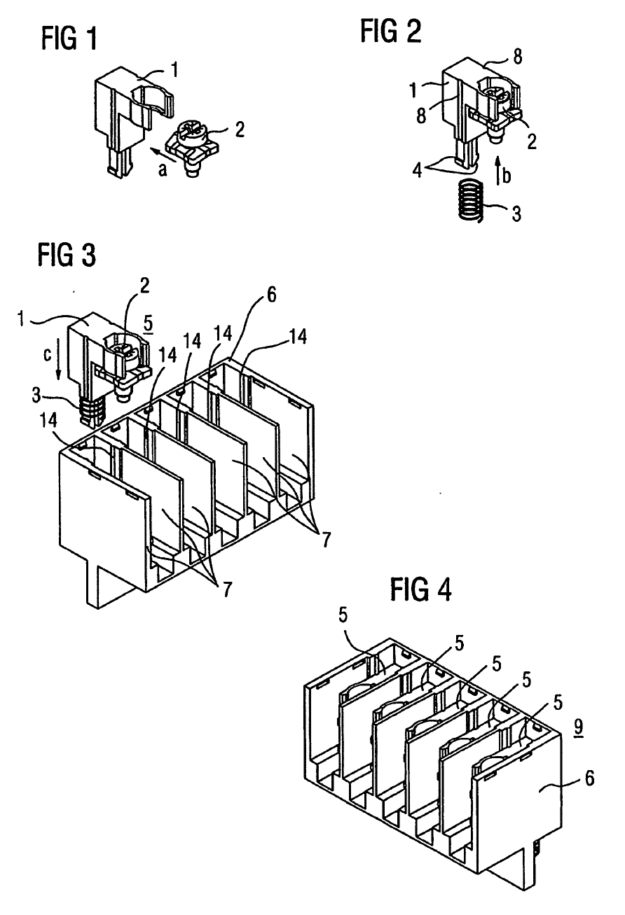

FIG. 1 shows a holder 1 and a screw-and-washer assembly 2 in the unmounted state. The holder 1 has a round opening matched to the screw head for accommodating the screw-and-washer assembly 2. The associated mounting device is indicated by the arrow a. A spring element 3 is pushed onto a lower protrusion with latching hooks 4 of the holder 1 in the direction shown by arrow b in FIG. 2 such that it cannot become detached.

The holder 1 also has guide grooves 8 on opposite side faces in order to push the preassembled component 5 shown in FIG. 3 into a correspondingly designed connection chamber of a housing having side walls 7 in a guided manner in the direction of the arrow c. For this purpose, the side walls 7 are equipped with guide webs 14. The guide webs 14 also serve the purpose of holding the component 5 in the housing 6.

The housing 6 of the switching device 13 according to at least one embodiment of the invention has, as shown in FIG. 3, a plurality of such connection chambers. It is possible for a component 5 of the above-described design to be inserted into each of these connection chambers for the purpose of connecting a conductor via a ring terminal. The overall unit including the housing 6 and the inserted components is referred to as the clamping device 9 (FIG. 4).

FIG. 5 shows a cross section through the clamping device 9 with the component 5 in the mounted state, which is latched into the housing 6 via a latching hook 10 such that it cannot be detached. The connection piece 11 is arranged on the base of the housing 6 and forms, together with the screw-and-washer assembly 2, a clamping point for the conductor connection via a ring terminal.

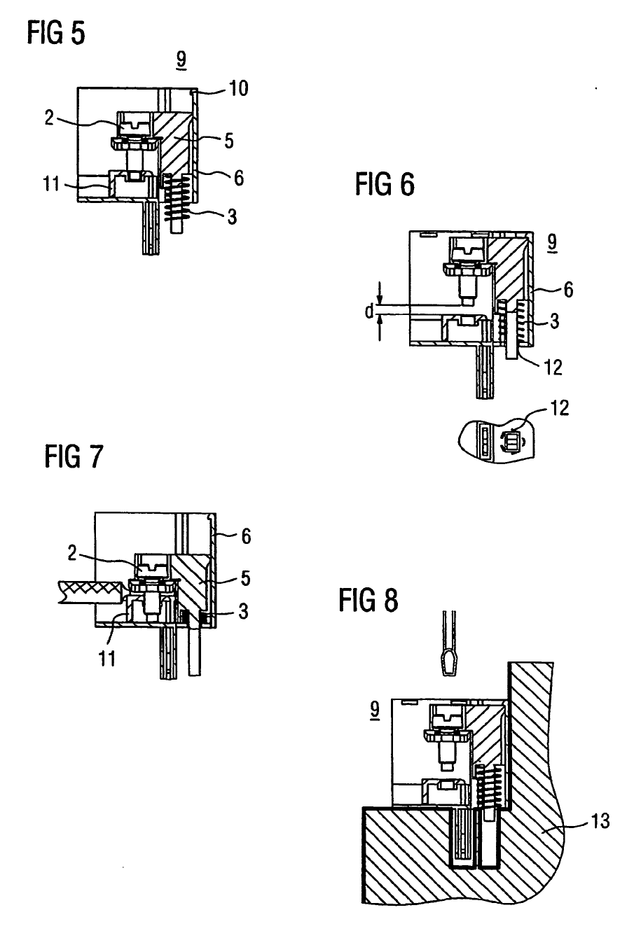

FIG. 5 also shows the position of the component before the clamping device, as the connection module, is plugged onto the device (alternative 1). FIG. 6 shows the clamping point in the open state, i.e. the distance d for mounting of the ring terminal is predetermined.

In order to hold the screw-and-washer assembly 2 shown in FIG. 6 in the open state of the clamping point, which state makes insertion of a ring terminal possible for the purpose of electrically connecting an electrical conductor connected to said ring terminal, a narrow point 12 is provided in the housing 6, the spring element 3 being supported on the narrow point 12 (alternative 2).

As shown in FIG. 7, the clamping point is in the closed state, i.e. the screw has been screwed into the thread of the connection piece 11.

FIG. 8 shows a cross section through a detail of the switching device 13 with a clamping device 9 (shown in FIG. 5) snapped on, in the case of which the spring element 3 is prestressed by the switching device 13.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A switching device for the connection of a conductor via a ring terminal, comprising:
a preassembled component including holder and a screw-with-washer assembly, the a screw-with-washer assembly being held by the holder and forming, together with a connection piece, a clamping point for the conductor connection via the ring terminal,
the holder being movable between an open and a closed state of the clamping point and including a spring element applied to the holder, which holds the holder in the open state when the clamping point is released.

2. The switching device as claimed in claim 1, wherein
the component is not provided with a cover.

3. The switching device as claimed in claim 1, wherein
the component is guided and held via guide grooves during assembly.

4. The switching device as claimed in claim 1,
wherein the complete clamping device is in the form of a module, the switching device plugged on, and the spring element being prestressed over a narrow point in the switching device.

5. The switching device as claimed in claim 2, wherein the component is guided and held via guide grooves during assembly.

6. The switching device as claimed in claim 2, wherein the complete clamping device is in the form of a module, the switching device being plugged on, and the spring element being prestressed over a narrow point in the switching device.

7. The switching device as claimed in claim 3, wherein the complete clamping device is in the form of a module, the switching device being plugged on, and the spring element being prestressed over a narrow point in the switching device.
